(19) United States
(12) Patent Application Publication
(10) Pub. No.: US 2017/0003574 A1
(43) Pub. Date: Jan. 5, 2017

(54) SYSTEMS AND DEVICES FOR MODULAR PORTABLE LIGHTING

(71) Applicant: Hanel CHOI, Ridgefield Park, NJ (US)

(72) Inventor: Hanel CHOI, Ridgefield Park, NJ (US)

(21) Appl. No.: 15/200,259

(22) Filed: Jul. 1, 2016

Related U.S. Application Data
(60) Provisional application No. 62/188,155, filed on Jul. 2, 2015.

(51) Int. Cl. G03B 15/07; H05B 37/02; F21V 21/22; F21L 4/06; F21V 23/00

(52) U.S. Cl. CPC G03B 15/07; F21L 4/06; F21V 23/008; F21V 21/22; F21V 23/002; H05B 37/0272; F21Y 2115/10

(57) ABSTRACT

Modular lighting systems having light heads, lighting poles or stands connected to and transferring power to the light head, a power pack connected to and transferring power to the lighting pole or stand, and a light meter in communication with the power pack. Power-transferring and data transferring modular light poles or stands, having telescoping portions, conductors of power and data therein, and first and second mounts. Power packs for modular lighting systems having casings, communication devices adapted to communicate with a light head or a flash head, and first and second mounts.

This application claims the benefit of, and priority to, U.S. Provisional Application Ser. No. 62/188,155, filed Jul. 2, 2015.

### FIELD OF THE INVENTION

The present invention relates in general to lighting and camera systems and devices.

### BACKGROUND OF THE INVENTION

The current studio and photographic lighting industry has made advances in Through The Lens (TTL) flash exposure metering and high speed sync (HSS). Major lighting devices frequently incorporate one of the following combinations of feature:

SETUP A:
a. studio light head
b. light stand or a lighting pole
c. power pack/battery
d. light modifier such as a softbox
e. cable to transfer power from the power pack (c) to the light head (a)
f. light controller that sits on camera
g. 15+ pound sandbag
h. light meter (optional)

In this setup, the studio light head (a) is attached to a light stand (b), which is stabilized by a sandbag (g). The cable (e) connects the head to the battery pack (c) that usually sits on the floor.

SETUP B:
a. studio light head with onboard battery holder
b. light stand or a lighting pole
c. power pack/battery that attaches directly to the head
d. light modifier such as a softbox
e. light controller that sits on camera
f. 15+ pound sandbag
g. light meter (optional)

In this setup, the studio head (a) is attached to a light stand (b), which is stabilized by a sandbag (f).

Both of the above setups use either use extensive cables, and/or have significant weight at the far end of the light stand. When a lighting pole is used, it is generally held by an assistant, who also carries either the battery pack of setup A, or carries the head, battery and light modifier at the far end of the lighting pole.

Currently existing light meters may sometimes use a touch screen or a radio chip to trigger lights. The usual method of use often involves:
1. set camera setting
2. set the power setting of the flash manually by guessing an approximate level of power
3. walk to the position of the subject
4. meter the light
5. read the light meter reading
6. calculate the difference between the light's power output to the camera's setting
7. walk to the light
8. adjust the light power or camera settings
9. walk back to the position of the subject
10. meter the light again to confirm
11. repeat for each light on studio set

### SUMMARY OF THE INVENTION

The present invention provides, in certain embodiments, for modular lighting systems having light heads 10, lighting poles or stands 20 connected to and transferring power to the light head 10, a power pack 30 connected to and transferring power to the lighting pole or stand 20, and a light meter 50 in communication with the power pack 30.

The present invention further provides, in other embodiments, for power-transferring and data-transferring modular light poles or stands 20, haying telescoping portions, conductors of power and data (21; 22) therein, and first and second mounts 52.

Yet other embodiments provide for power packs for modular lighting systems having casings, communication devices adapted to communicate with a light head 10 or a flash head, and first and second mounts 52.

### BRIEF DESCRIPTION OF THE DRAWINGS

FIG. 1 shows a light head 10 with mount 52 and power/electrical and data contacts 150, the frontward ones of which may be used for mounting from the front of the light head, according to an embodiment of the present invention.

FIGS. 24-2C show a full view and two exploded views a lighting pole or stand 20 and power pack 30 according to an embodiment of the present invention. The lower portion of FIG. 2B further shows what may be a standard light stand tip size, according to embodiments of the present invention. FIG. 2C further shows a lock/unlock lever 160.

FIG. 3 shows lighting pole or stands 20 according to embodiments of the present invention, which, in certain embodiments of the present invention, may employ a mount option 1 (90) or mount option 2 (91) at its upper end. and may employ mount option 2 (91) at its lower end.

FIG. 4 shows lighting pole or stands 20 with legs 70 according to embodiments of the present invention.

FIG. 5 shows a power pack 30 according to an embodiment of the present invention.

FIG. 6 shows a light meter 50 according to an embodiment of the present invention, which may, in certain embodiments of the present invention, have a communication antenna 11, which may, for example, be a WiFi, Bluetooth, or radio antenna.

FIG. 7 shows, from the top of the drawing sheet to the bottom, a top view, front view, and bottom view, respectively, of a smart light meter 50 with built-in light controller, according to an embodiment of the present invention.

FIG. 8 shows a charger base 110 and power pack 30 according to an embodiment of the present invention.

FIG. 9 shows a device 120 that converts a pole (such a power-transferring and data-transferring light pole 20) into a boom light stand, according to an embodiment of the present invention.

FIG. 10 shows a convener between Mount Option 1 (90) and Mount Option 2 (91), according to an embodiment of the present invention.

FIG. 11 shows a LED strip light attachment 130 according to an embodiment of the present invention.

FIG. 12 shows a speedring 80, which may have a locking mechanism 170, according to an embodiment of the present invention.

### DETAILED DESCRIPTION OF THE DRAWINGS AND PREFERRED EMBODIMENTS

According to embodiments of the present invention, a modular lighting system comprising one or more or all of the following parts may be used.

a. light head 10, which may be a small studio light head or which may be other light heads as are known in the art;

b. lighting pole or stand 20, which may be modular and/or power-transferring, and/or data-transferring;

c. power pack 30, which may connect, and may directly connect, to the lighting pole or stand 20, and may have two-way communication with the light meter 50, which two-way communication may be built-in;

d. light modifier 40, which may be a softbox, or which may be other light modifiers as are known in the art; and

e. light meter 50, which may be a smart light meter, and which may have a built-in light controller 51 and/or mount 52, which mount may be adapted for, or allow, mounting on a camera. It will be understood to one of ordinary skill in the art that the light meter 50 can be standalone or non-standalone (e.g. a smartphone or other device attached by headphone jack or by cable to an attachment having standalone light meter functions).

The light head 10 may attach to and/or receive power through the lighting pole or stand 20, which lighting pole or stand 20 may itself attach to and/or draw power from the power pack 30. The other end of the power pack 30 may be attached to other modifiers, such as legs 70 to create a freestanding lighting stand, and/or an additional battery, and/or a charger base. The power pack 30 may have a built-in mode of communication such as, Wi-Fi, Bluetooth, or radio, or other modes of communication known to one of skill in the art.

Systems of the present invention may be created without the use of cables, or may use fewer cables than in the lighting systems of the prior art.

In certain embodiments of the present invention, the system does not include, and/or is used without, one or more or all of the following components: onboard battery holder (such as that of a studio light head); separate power pack; battery; cables, such as cables transferring power from a power pack or power source to a light head; light controller, such as a light controller sitting on a camera; and sandbag, such as a 15+ pound sandbag.

In embodiments of the present invention, the power pack 30 is placed at the opposite end of the lighting pole or stand 20 as the light head 10, and functions as a counterweight. The systems of the present invention may avoid the use of further counterweights, such as sandbags.

In certain embodiments of the present invention, the light meter 50 adjusts the light output power by communication, which may be two-way communication, with the power pack 30. In a further embodiment the light meter 50 may calculate the needed power for a desired amount of light and adjust the power output of the power pack 30 to match this power level.

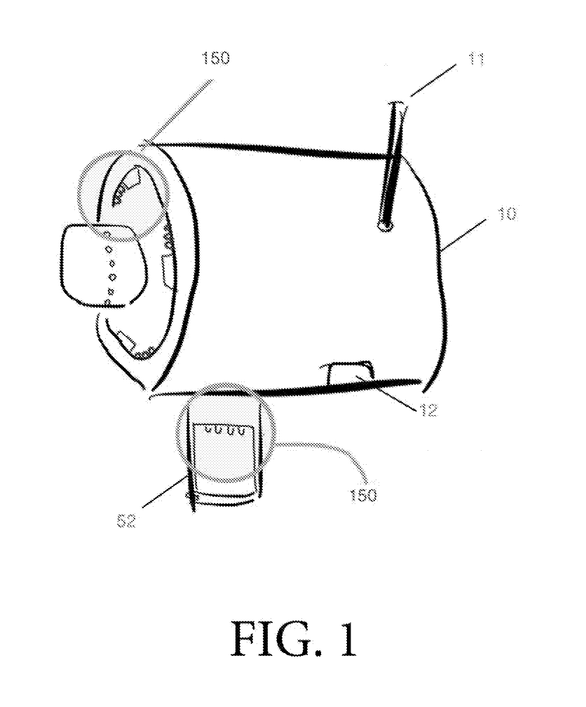

FIG. 1 shows an embodiment of a studio light head in accordance with one embodiment of the present invention. The studio light head 10 as shown in FIG. 1 may be a small version of a flash head, and may contain a flash tube, LED modeling light, light modifier mount, and communication antenna 11 and/or antennae for Wifi/Bluetooth/Radio or other communication or wireless communication technologies as are known to one of ordinary skill in the art. It may draw power directly through a mount 52 having power and data contacts 150, and may have a power cable port 12 built-in. It may also be adapted to mount from the front to a powered light modifier speedring 80, by way of example, the powered light modifier speedring 80 shown and described in connection with FIG. 12, and may draw power and/or transfer data through there. The power and data contacts 150 may, in certain embodiments, be similar to those used on camera bodies and lenses, where, when the lens is mounted to the camera body, the raised contacts on both the lens and the camera body align and transfer data and power to power the auto focus motor on the lens and adjust the amount of focus needed.

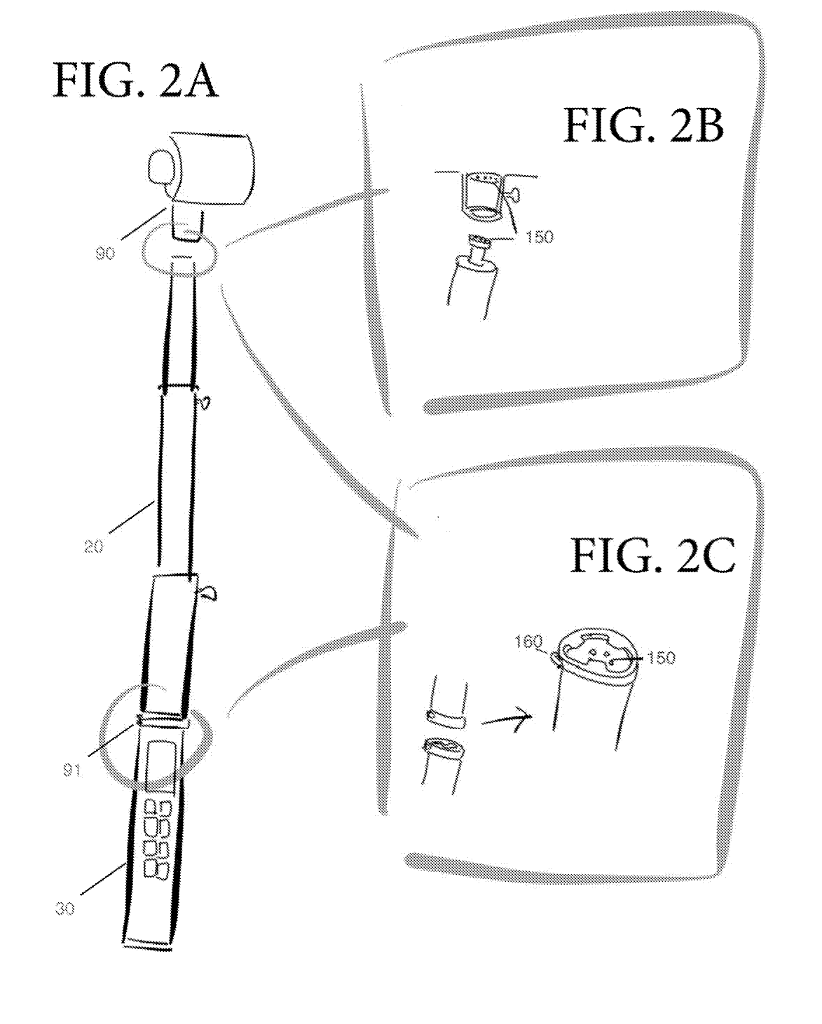

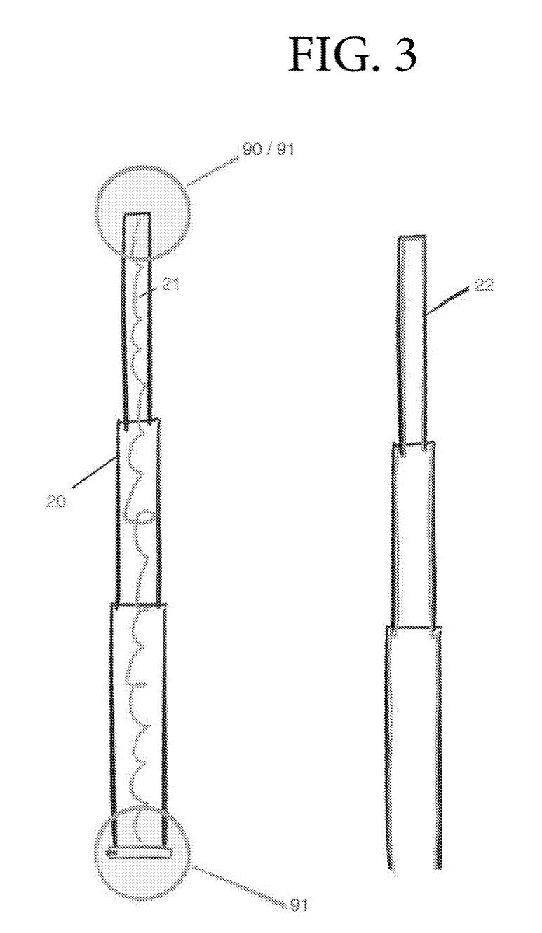

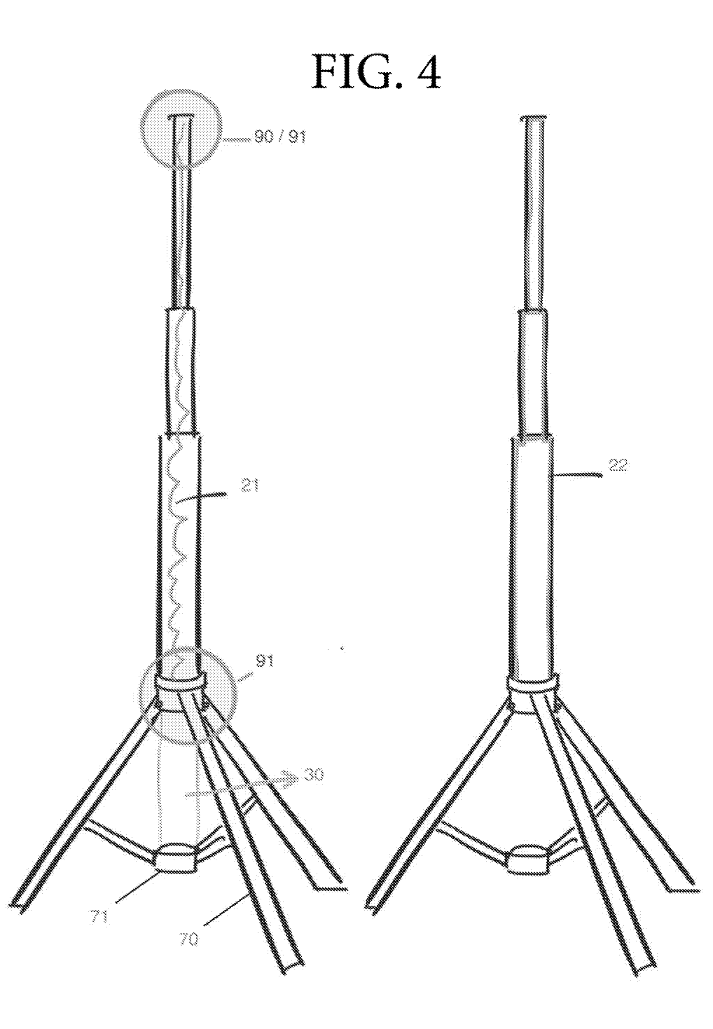

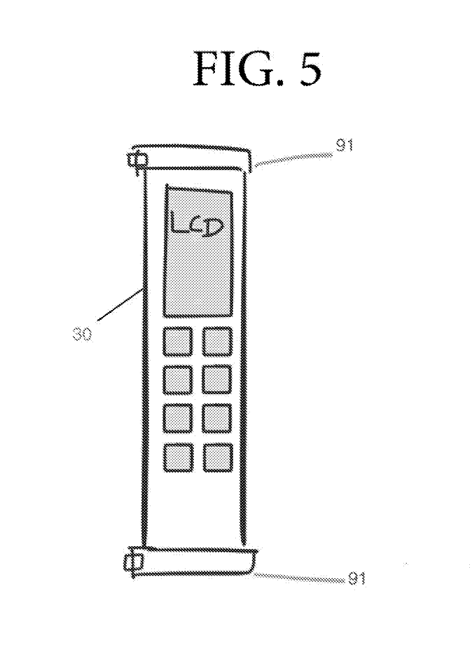

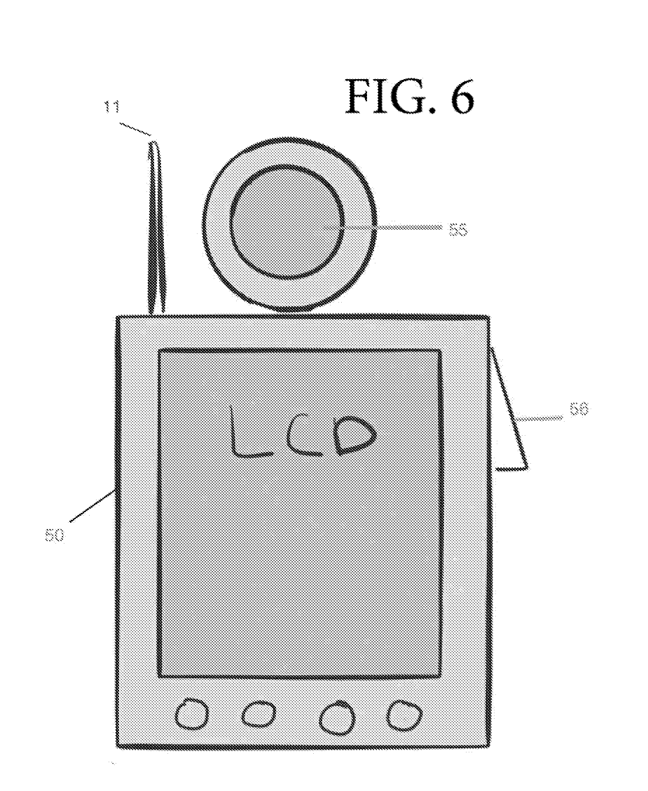

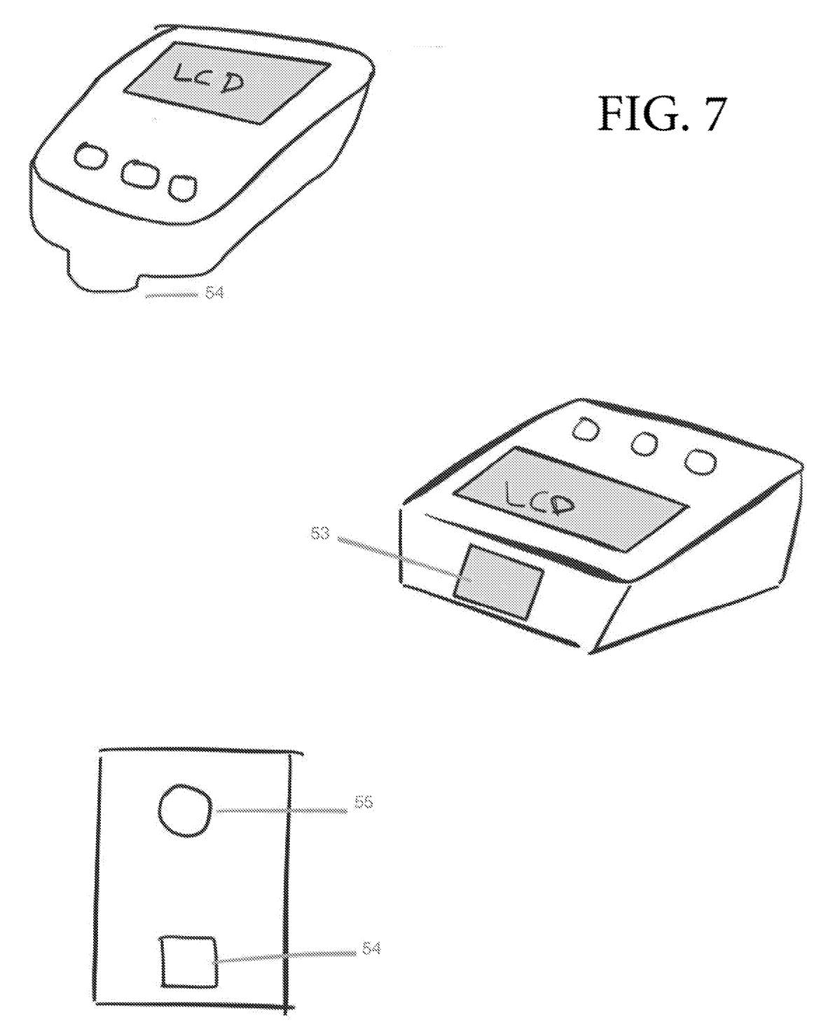

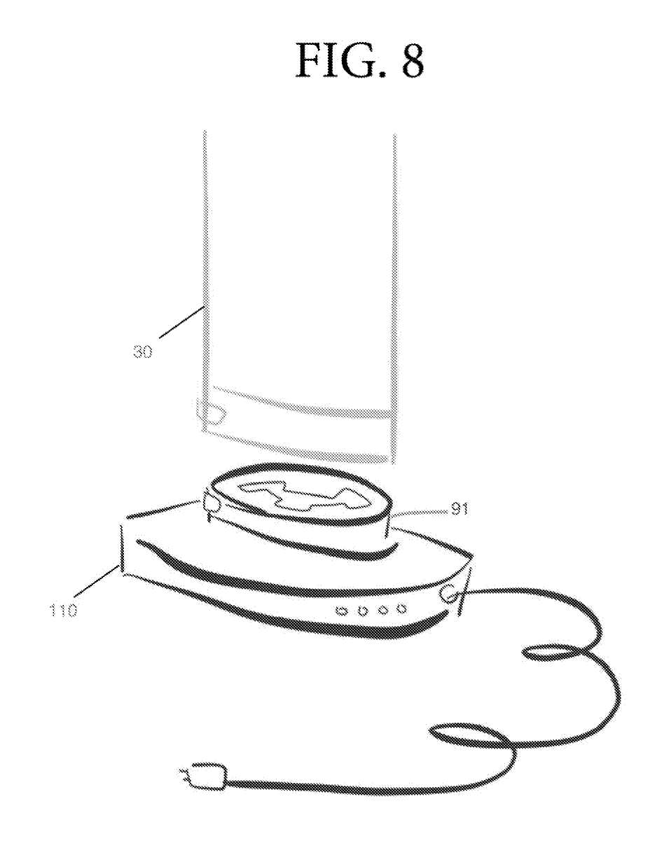

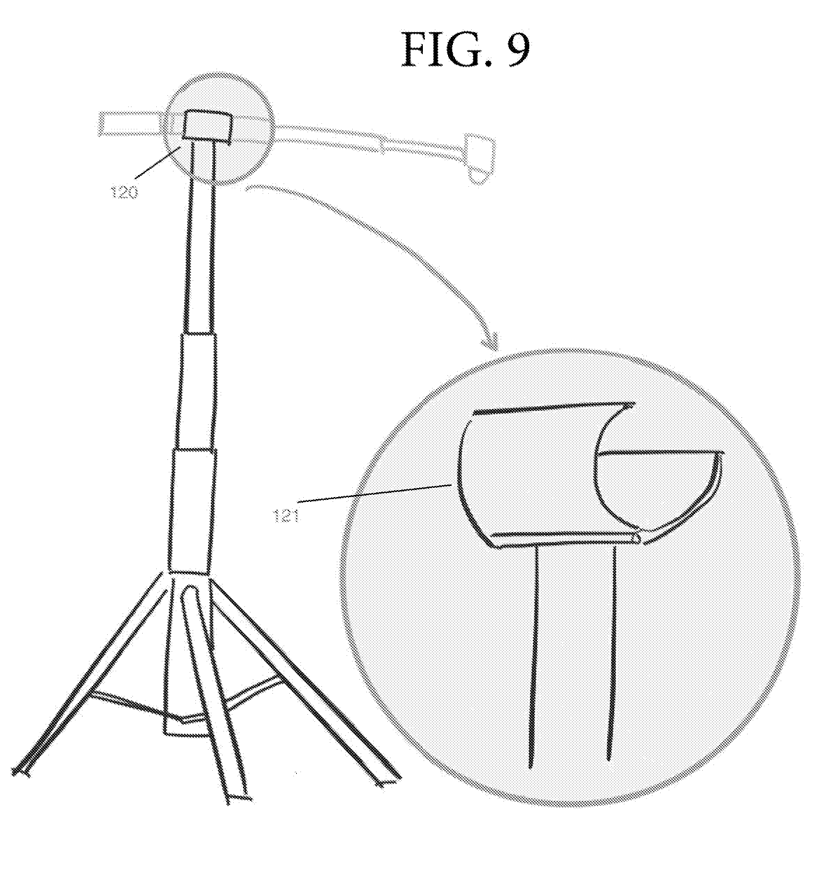

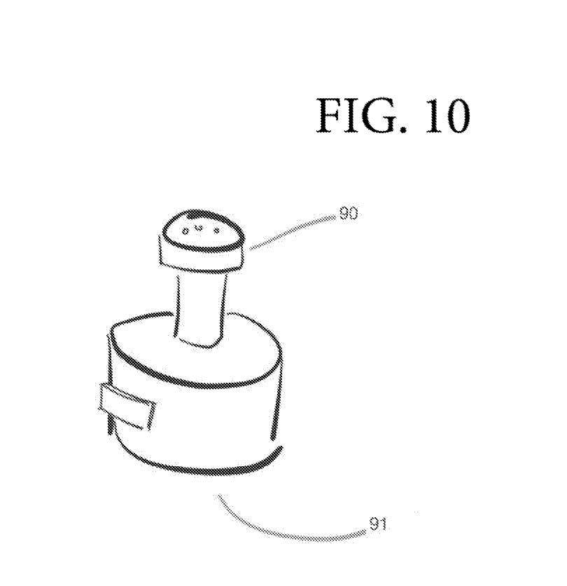

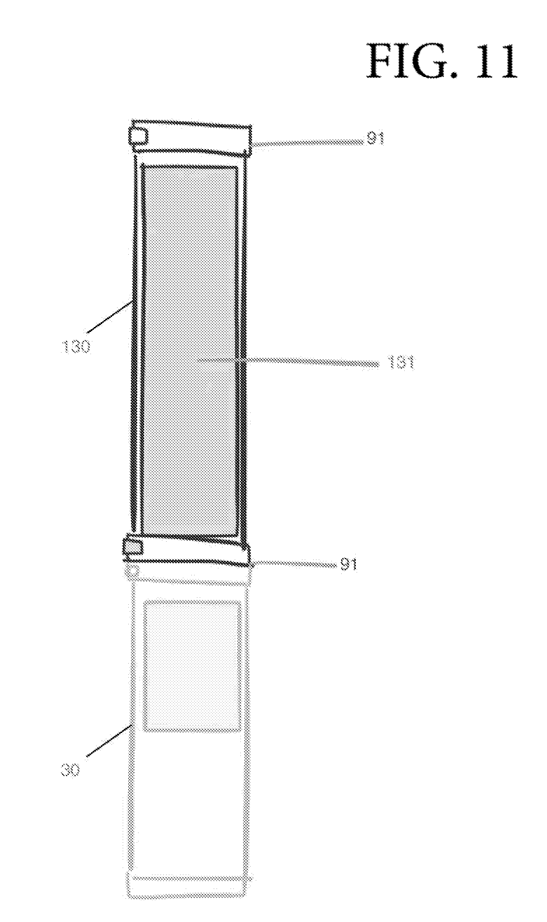

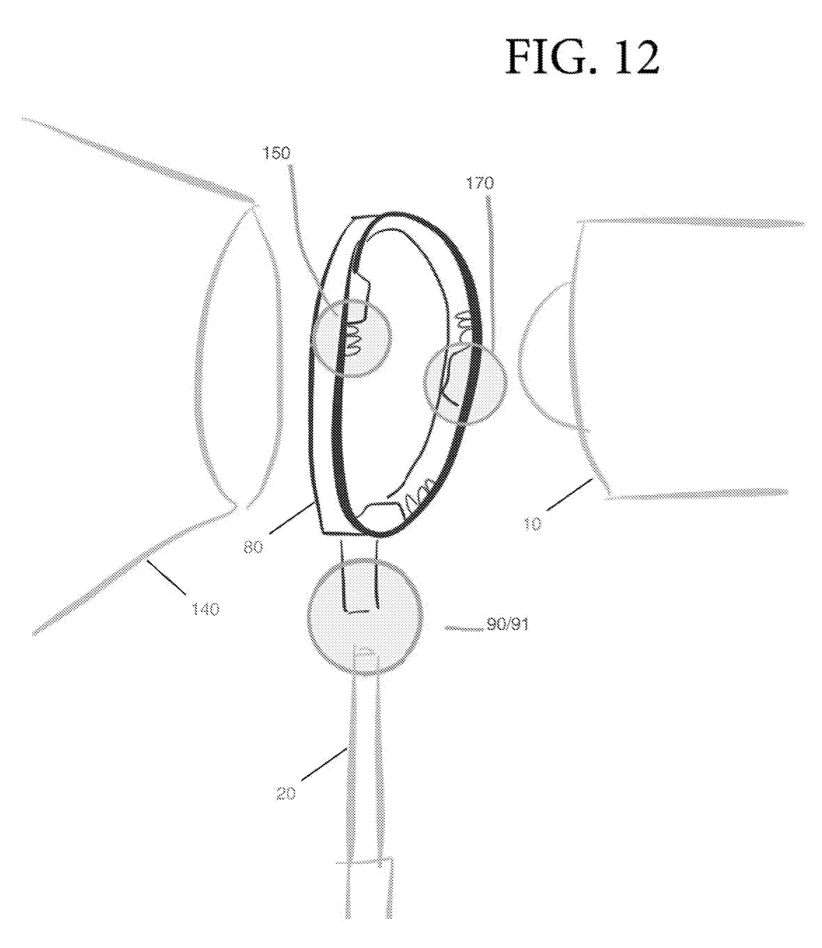

FIG. 2B, an exploded and detailed view of a portion of FIG. 2A, shows a mount option according to one embodiment of the present invention, in the form of a modified light stand. According to this embodiment, the light head 10. such as a studio light head, is connected to a power-transferring modular light stand, for example, through a moth tied light stand adapter 90 with built-in power and communication contacts. Such an adapter 90 may allow the light head 10 to connect to existing light stands and accessories. A power cable port 12 may be used to draw power, for example, when the light head 10 is mounted to an existing traditional light stand lacking power.

FIG. 2C, an additional exploded and detailed view of a portion of FIG. 2A, shows an additional mount option according to an embodiment of the present invention. According to this embodiment, the light head 10, such as a studio light head, is connected to a power-transferring modular light stand 20, for example, through a locking mount 91, which may be proprietary, similar to that of lens mounts for cameras. The light head 10 may be locked in place by the locking mount 91 so as to align power and/or communication contacts to provide the light head 10 with power and communication to and/or from the battery pack 30.

A power-transferring and data-transferring modular light pole 20 according to one embodiment of the present invention is shown in FIG. 3. The pole of this embodiment may telescope and may have built-in power-transferring and data-transferring capability, by, for example, a built-in power & data cable 21 or having the pole body built-in with electrically conductive and data ribbon lining 22. Other conductors of power and information as are known to one of ordinary skill may also be used. The far end of the pole 20 may use Mount Option 1 (90 discussed above in connection with FIG. 2B) or Mount Option 2 (91 discussed above in connection with FIG. 2C). The close end may use Mount Option 2 (91 discussed above in connection with FIG. 2C), and this mount may be used to attach a power pack 30 and/or other accessories. Alternately, other mounts as are known in the art may be used for either or both ends.

A power-transferring and data-transferring modular light stand 20 according, to one embodiment of the present invention is shown in FIG. 4. The light stand of this embodiment may telescope and may have built-in power-transferring and data-transferring capability, by, for example, a built-in power & data cable 21 or having the pole 10 body built-in with electrically-conductive and data conductive ribbon lining 22. Other conductors of power and information as are known to one of ordinary skill may also be used. The top end of the pole 20 may use Mount Option 1 (90 discussed above in connection with FIG. 2B) or Mount Option 2 (91 discussed above in connection with FIG. 2C). The close end may use Mount Option 2 (91 discussed above in connection with FIG. 2C), and this mount may be used to attach a power pack 30 and/or other accessories. Alternately, other mounts as are known in the art may he used for either or both ends. The bottom end may additionally have light stand legs 70, such as three light stand legs. A support 71 may be included between the legs 70, which support 71 may support the lower end of a power pack 30 or other accessory.

A power pack 30 with built-in two way communication with a smart light meter 50 according to an embodiment of the present invention is shown in FIG. 5. The power pack 30 according to this embodiment may serve as the controller and battery for a studio light head 10 and/or studio flash head. Mount Option 2 (91 discussed above in connection with FIG. 2C) may be used on each end of the power pack 30. Alternately, other mounts as are known in the art may be used for either or both ends. One end of the power pack 30 may attach to a power-transferring and data-transferring modular light pole or stand 20. The other end may be used for attachment to legs 70 for conversion to a light stand, for attachment to an additional battery (making additional power available), and/or for attachment to a cable (such as a cable providing AC or other electrical power) or other accessory or accessories.

A smart light meter 50, which may be stand-alone, according to an embodiment of the present invention is shown in FIG. 6. The smart light meter 50 according to this embodiment may have built-in two way communication, for example, with a power pack 30 that is a part of the various modular lighting setups discussed herein. It may have a sensor 55 and a read button 56. The meter 50 may calculate the correct power output for the power pack for a desired lighting level and communicate the power output to the power pack 30, for example, by wireless communication including Wi-Fi, Bluetooth, Radio, or IR, or other forms of communication or wired communication known to one of skill in the art. The meter may also or alternatively be able to directly or indirectly communicate reading measurements or other light meter data, such as by wireless communication, to a light source and/or battery pack. Such light source and/or battery pack may use this data to produce the needed amount of light, or produce power appropriate to produce the needed amount of light.

A smart light meter 50 with built-in light controller, according to an embodiment of the present invention, is shown m FIG. 7. The meter according to this embodiment may control the settings of the light head 10 wirelessly or by wired communication. The meter may have a hot shoe mount 54 to mount it to the camera and/or an AF assist lamp 53 to help focus in low light.

Additional accessories according to various embodiments of the present invention, which may be used with the above embodiments of the present invention, are discussed in connection with FIGS. 8-12.

FIG. 8 shows a power pack 30 charging base 110. It may employ Mount Option 2 (91 discussed above in connection with FIG. 2C), through which the power pack 30 may be charged.

FIG. 9 shows a device 120 that converts a pole (such a power-transferring and data-transferring light pole 20) into a boom light stand. It may comprise a heavy-duty stand with a grip 121 to hold the pole on top as a boom arm. The stand may be balanced by the countervailing weights of a power pack and a light head 10 opposite each other on the pole.

FIG. 10 shows a converter between Mount Option 1 (90) and Mount Option 2 (91), which for example may allow a light head with Mount Option 1 (90) to mount directly to a power pack 30, such as for hand-held use.

FIG. 11 shows a LED strip light attachment 130. This attachment may be a tube with LED lights 131. The LED lights 131 may all face in one direction or may face in different directions. Mount Option 2 (91) may appear on each end. This attachment may be attached to a modular light pole 20 or directly to a power pack 30, and may then draw power and give off light based on an adjustable power amount. This attachment may be controllable, such as wirelessly through a smart light meter 50 with built-in light controller employing the power pack's 30 built-in wireless communication device.

FIG. 12 shows a powered light modifier speedring 80, which may be used to mount the light head 10 to a light pole, such as a power-transferring and data-transferring light pole. The speedring 80 may be used to mount halt modifiers 140 such as soft boxes on one side and may also have a connection with built-in power and data contacts on the other side for power and data communication with the light head or studio light head 10. The bottom may have Mount Option 1 (90).

While the invention has been described by way of example and in terms of particular embodiments, it is to be understood that the invention is not limited to the disclosed embodiments. To the contrary, it is intended to cover various modifications and similar arrangements as would be apparent to those skill in the art.

Parts List:
light head 10
communication antenna 11
power cable port 12
lighting pole or stand 20
power & data cable 21
ribbon lining 22
power pack 30
light modifier 40
light meter 50
mount 52
AF assist lamp 53
hot shoe mount 54
sensor 55
read button 56
legs 70
support 71
speedring 80
adapter 90
locking mount 91
charging base 110
device 120
grip 121
LED strip light attachment 130
LED lights 131
light modifier 140
power and data contacts 150
lock/unlock lever 160
locking mechanism 170

What is claimed is:

1. A modular lighting system comprising:
a light head;
a lighting pole or stand connected to and transferring power to the light head;
a power pack connected to and transferring power to the lighting pole or stand; and
a light meter in communication with the power pack.

2. The modular lighting system of claim 1, further comprising a light modifier connected to the light head.

3. The modular lighting system of claim 1, wherein the light head is a studio light head.

4. The modular lighting system of claim 1, wherein the power pack directly connects to the lighting pole or stand and is in two-way communication with the light meter.

5. The modular lighting system of claim 4, wherein the power pack is attached to the lighting pole or stand at a first end of the power pack and is attached to an object at a second, opposite, end of the power pack.

6. The modular lighting system of claim 5, wherein the object is a lighting stand.

7. The modular lighting system of claim 5, wherein the object is a battery.

8. The modular lighting system of claim 5, wherein the object is a charger base.

9. The modular lighting system of claim 1, wherein the light meter has a built-in light controller.

10. The modular lighting system of claim 1, wherein the light meter has a mount.

11. The modular lighting system of claim 1, wherein the power pack has built-in wireless communication with which the power pack communicates with the light meter.

12. The modular lighting system of claim 1, wherein the lighting pole or stand is connected at a first end to the power pack and is connected at a second, opposite, end to the light head.

13. The modular lighting system of claim 12, wherein the power pack functions as a counterweight to the light head.

14. The modular lighting system of claim 1, wherein the light meter adjusts light output through communication with the power pack.

15. The modular lighting system of claim 14, wherein the light meter calculates a power level for a desired amount of light and adjusts power output of the power pack based on this power level.

16. The modular lighting system of claim 1, wherein the lighting pole or stand transfers power and data to the light head through an adapter having built-in power and communication contacts.

17. The modular lighting system of claim 1, wherein the lighting pole or stand is connected to the light head through a locking mount aligning power and communication contacts and thereby providing the light head with power and communication from the battery pack.

18. A power-transferring and data-transferring modular light pole or stand, comprising:
an telescoping portion;
a conductor of power and data within the telescoping portion;
a first mount at a first end of the telescoping portion; and
a second mount at a second, opposite, end of the telescoping portion.

19. The power-transferring and data-transferring modular light pole or stand of claim 18, wherein the conductor of power and data is a cable.

20. The power-transferring and data-transferring modular light pole or stand of claim 18, wherein the conductor of power and data is a ribbon lining an interior of the telescoping portion.

21. The power-transferring and data-transferring modular light pole or stand of claim 18, wherein the second mount is a locking mount adapted to align power and communication contacts.

22. The power-transferring and data-transferring modular light pole or stand of claim 21, wherein the first mount is a locking mount adapted to align power and communication contacts.

23. The power-transferring and data-transferring modular light pole or stand of claim 21, wherein the first mount is an adapter with built-in power and communication contacts.

24. The power-transferring and data-transferring modular light pole or stand of claim 18, wherein the modular light pole or stand further comprises:
light stand legs at the second end;
a support between the light stand legs adapted to support an accessory.

25. The power-transferring and data-transferring modular light pole or stand of claim 24, wherein the accessory is a power pack and the support is adapted to support the power pack at a lower end of the power pack.

26. A power pack for a modular lighting system, comprising:
a casing;
a two way communication device within the casing adapted to communicate with a light head or a flash head;
a first mount at a first end of the casing; and
a second mount at a second, opposite, end of the casing.

27. The power pack of claim 26, wherein the first mount is a locking mount adapted to align power and communication contacts.

28. The power pack of claim 27, wherein the second mount is a locking mount adapted to align power and communication contacts.

29. The power pack of claim 27, wherein the first mount attaches the power pack to a power-transferring and data-transferring modular light pole or stand.

30. The power pack of claim 26, wherein the second mount attaches the power pack to an accessory.

31. The power pack of claim 30, wherein the accessory is light stand legs.

32. The power pack of claim 30, wherein the accessory is a battery.

33. The power pack of claim 30, wherein the accessory is a cable.
